(19) United States
(12) Patent Application Publication
(10) Pub. No.: US 2019/0228360 A1
(43) Pub. Date: Jul. 25, 2019

(54) PRODUCTION SCHEDULE CREATING APPARATUS, PRODUCTION SCHEDULE CREATING METHOD, AND PRODUCTION SCHEDULE CREATING PROGRAM

(71) Applicant: Hitachi, Ltd., Tokyo (JP)

(72) Inventors: Yoshiki AOYAMA, Tokyo (JP); Yuichi KOBAYASHI, Tokyo (JP)

(21) Appl. No.: 16/333,713

(22) PCT Filed: Nov. 28, 2017
(86) PCT No.: PCT/JP2017/042632

§ 371 Date: Mar. 15, 2019

(30) Foreign Application Priority Data
May 31, 2017 (JP) PCT/JP2017/020257

(51) Int. Cl. G06Q 10/06; G06Q 50/04; G05B 19/418; G06N 20/00

(52) U.S. Cl. CPC G06Q 10/06314; G06Q 50/04; G05B 2219/32247; G06N 20/00; G05B 19/41865

(57) ABSTRACT

To make it possible to plan and provide a new production schedule reflecting characteristics or tendencies appearing in production schedules planned in the past. A schedule planning section calculates, on the basis of history information concerning production schedules of products planned in the past, a schedule pattern including production order of the products while considering constraint conditions in producing the products, rearranges the production order of the products according to the calculated schedule pattern, and creates a plurality of schedule candidates concerning a production schedule of the products. A schedule evaluating section evaluates the plurality of schedule candidates on the basis of evaluation indicators corresponding to the constraint conditions, and selects a best production schedule out of the plurality of schedule candidates.

### TECHNICAL FIELD

The present invention relates to a production schedule creating apparatus, a production schedule creating method, and a production schedule creating program and, more particularly, relates to a production schedule creating apparatus, a production schedule creating method, and a production schedule creating program that are suitably applied to a production schedule creating apparatus that creates a production schedule of products.

### BACKGROUND ART

There are a large number of events in which production order and work order are schedule in advance such as manufacturing of products in a factory and development of a large scale system. In planning of such a schedule, it is necessary to plan an optimum schedule according to a situation while considering constraints such as resources of equipment and personnel, time, or temperature. In such schedule planning, since there is a limit in manual planning, in more cases, schedules are planned by applying an algorithm such as mathematical planning using computers.

On the other hand, concerning constrains considered in the schedule planning, it is difficult to decide constraint conditions matching an actual situation in a site when the constraint conditions are actually large and complicated or decided implicitly by a rule of thumb or an intuition of a planner who creates a plan. In conventional techniques, a technique for assisting efficient decision of constraint conditions focusing on the problems described above is publicly known. In a first conventional technique, constraint conditions are relaxed by learning a history of schedules planned in the past while considering obvious constraint conditions given in advance (see PTL 1). In a second conventional technique, priority levels are given in advance to a plurality of constraint conditions in schedule planning for determining order and, when a schedule cannot be planned because constraints are strict, the constraint conditions are relaxed by changing the priority levels of the constraints (see PTL 1).

That is, in these conventional techniques, it is attempted to plan a schedule matching an actual situation in a site by tuning the constraint conditions according to the actual situation in the site.

### CITATION LIST

### Patent Literature

[PTL 1] Japanese Patent Application Laid-open No. 2016-189079

[PTL 2] Japanese Patent Application Laid-open No. H05-324665

### SUMMARY OF INVENTION

### Technical Problem

The conventional techniques explained above focus on only relaxing constraint conditions to eliminate violation of the constraint conditions. The first conventional technique is a method of sequentially relaxing violation of the constraint conditions that occurs at least once. When the constraint conditions are so excessively relaxed that a violation frequency in the past is exceeded, it is likely that a schedule not conforming to an actual situation in the past is planned. On the other hand, in the second conventional technique, it is likely that the quality of a schedule depends on setting of the priority levels, for example, a planner underestimates a priority level of a constraint condition that is actually a bottleneck.

The present invention has been devised considering the points described above and proposes a production schedule creating apparatus, a production schedule creating method, and a production schedule creating program that can plan and provide a new production schedule reflecting characteristics or tendencies appearing in production schedules planned in the past.

### Solution to Problem

In order to solve such problems, a production schedule creating apparatus according to the present invention includes: a schedule planning section that calculates, on the basis of history information concerning production schedules of products planned in the past, a schedule pattern including production order of the products while considering constraint conditions in producing the products, rearranges the production order of the products according to the schedule pattern, and creates a plurality of schedule candidates concerning a production schedule of the products; and a schedule evaluating section that evaluates the plurality of schedule candidates on the basis of evaluation indicators corresponding to the constraint conditions, and selects a best production schedule out of the plurality of schedule candidates.

A production schedule creating method in a production schedule creating apparatus that creates a production schedule of produces according to the present invention includes: a schedule planning step in which the production schedule creating apparatus calculates, on the basis of history information concerning production schedules of products planned in the past, a schedule pattern including production order of the products while considering constraint conditions in producing the products, rearranges the production order of the products according to the schedule pattern, and creates a plurality of schedule candidates concerning a production schedule of the products; and a schedule evaluating step in which the production schedule creating apparatus evaluates the plurality of schedule candidates on the basis of evaluation indicators corresponding to the constraint conditions, and selects a best production schedule out of the plurality of schedule candidates.

A production schedule creating program according to the present invention causes a computer to execute: a schedule planning step for calculating, on the basis of history information concerning production schedules of products planned in the past, a schedule pattern including production order of the products while considering constraint conditions in producing the products, rearranging the production order of the products according to the schedule pattern, and creating a plurality of schedule candidates concerning a production schedule of the products; and a schedule evaluating step for evaluating the plurality of schedule candidates on the basis of evaluation indicators corresponding to the constraint conditions, and selecting a best production schedule out of the plurality of schedule candidates.

### Advantageous Effects of Invention

According to the present invention, it is possible to create a new production schedule reflecting characteristics or tendencies of production schedules planned in the past.

### BRIEF DESCRIPTION OF DRAWINGS

FIG. 1 is a block diagram showing an example of a schematic configuration of a production schedule creating apparatus according to a first embodiment.

FIG. 2 is a block diagram showing an example of a software configuration of the production schedule creating apparatus shown in FIG. 1.

FIG. 3 is a flowchart showing an example of a production schedule creating method in the production schedule creating apparatus.

FIG. 4 is a flowchart showing an example of machine learning processing shown in FIG. 3.

FIG. 5 is a diagram showing an example in which a schedule history is accumulated.

FIG. 6 is a diagram showing an example in which a schedule pattern is created by a machine learning section.

FIG. 7 is a flowchart showing an example of teacher data conversion processing.

FIG. 8 is a diagram showing an example in which a schedule history is converted into teacher data.

FIG. 9 is a diagram showing an example in which an evaluation indicator parameter is calculated.

FIG. 10 is a diagram showing an example of accumulation in a machine learning result storage database.

FIG. 11 is a flowchart showing an example of schedule planning processing shown in FIG. 3.

FIG. 12 is a diagram showing an example in which a plurality of schedule candidates are created.

FIG. 13 is a flowchart showing an example of schedule evaluation processing shown in FIG. 3.

FIG. 14 is a diagram showing an example in which an optimum production schedule is selected.

FIG. 15 is a diagram showing an example of an input/output screen.

FIG. 16 is a diagram showing an example in which a production schedule created before is thereafter taken over and a new production schedule is created.

FIG. 17 is a diagram showing a configuration example of a production schedule creating apparatus according to a second embodiment.

FIG. 18 is a diagram showing an example in which an optimum production schedule is determined by the configuration shown in FIG. 17 in cooperation with an external sensor or an external system.

### DESCRIPTION OF EMBODIMENTS

Embodiments of the present invention are explained in detail below with reference to the drawings.

### (1) First Embodiment

### (1-1) Hardware Configuration

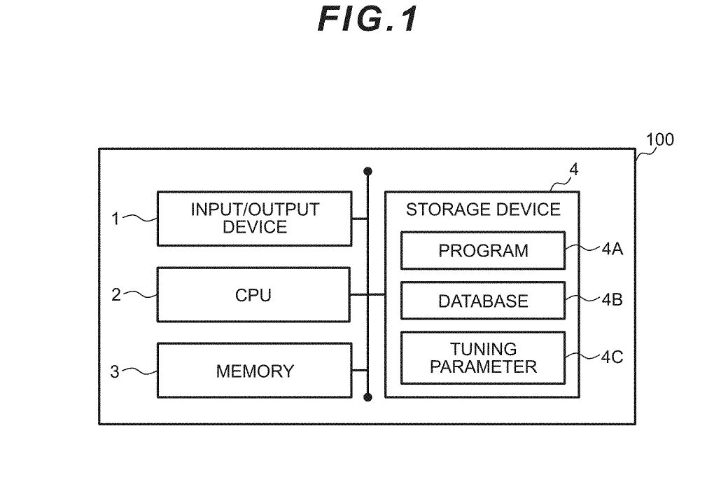

FIG. 1 shows an example of a schematic configuration of a production schedule creating apparatus 100 according to a first embodiment. The production schedule creating apparatus 100 is, for example, a computer and includes an input/output device 1, a CPU 2, a memory 3, and a storage device 4.

A program 4A, a database 4B, and a tuning parameter 4C are stored in the storage device 4. The database 4B includes a table as explained below. The table is referred to and updated by the program 4A.

### (1-2) Software Configuration

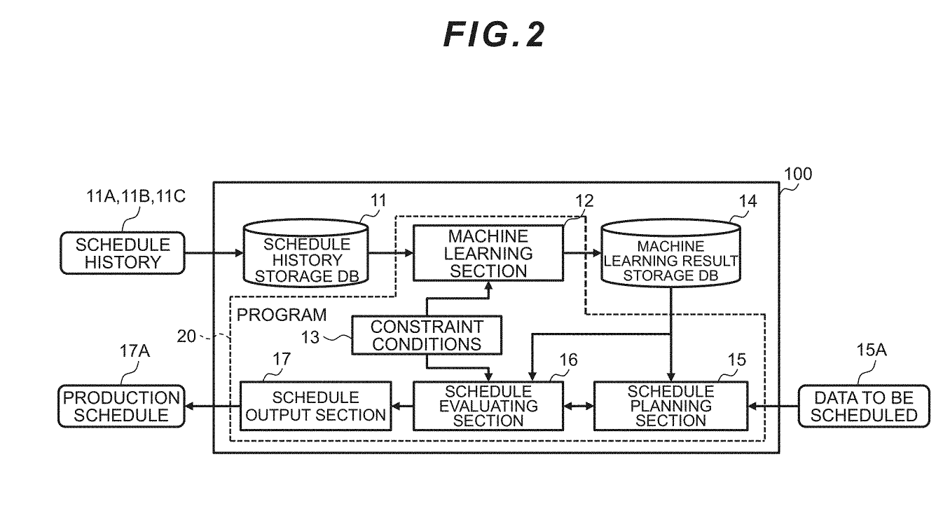

FIG. 2 shows an example of a software configuration of the production schedule creating apparatus 100 shown in FIG. 1. The production schedule creating apparatus 100 includes, besides a schedule history storage database (hereinafter abbreviated as “schedule history storage DB”) 11, as a program 20, for example, a machine learning section 12, a machine learning result storage database (hereinafter abbreviated as “machine learning result storage DB”) 14, a schedule planning section 15, a schedule evaluating section 16, and a schedule output section 17. Note that the program 20 may include the schedule history storage DB 11 and the machine learning result storage DB 14 in a concept of configuring software. The program 20 and the like referred to herein are equivalent to the program 4A and the like executed by the computer.

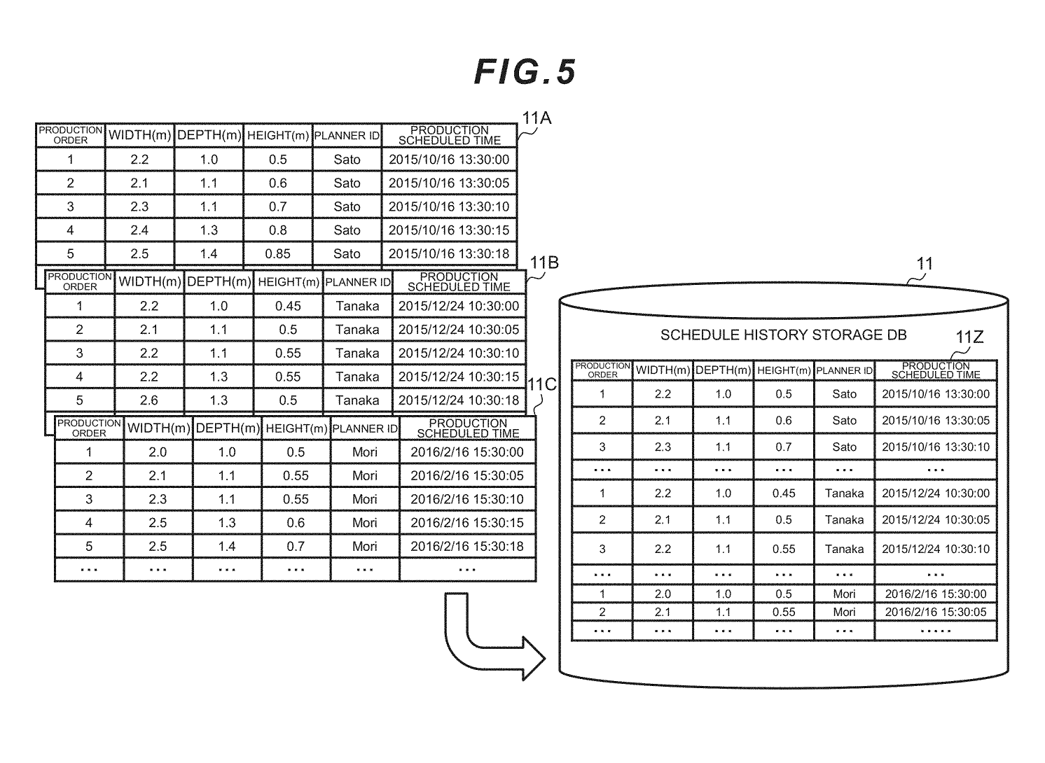

In the schedule history storage DB 11, schedules planned in the past are stored as schedule histories 11A, 11B, and 11C together with information such as planners and planning periods (see FIG. 5 referred to below). Details of the schedule history storage DB 11 are explained below.

The machine learning section 12 has a function of reading, from the schedule history storage DB 14, the schedule histories 11A, 11B, and 11C in a predetermined unit, that is, for example, for each planner and for each schedule period and outputting a schedule pattern according to machine learning.

The machine learning section 12 has a function of, as preprocessing, converting the schedule histories 11A, 11B, and 11C into a machine-learnable data format and creating teacher data. A conversion method into the teacher data is explained below.

The machine learning section 12 has a function of, in parallel to the processing explained above, a function of determining a parameter of an evaluation indicator (hereinafter referred to as “evaluation indicator parameter”) on the basis of the read schedule histories 11A, 11B, and 11C. Note that, in this embodiment, the evaluation indicator is referred to as “KPI” as well.

Specifically, first, the machine learning section 12 reads constraint conditions 13 and calculates a frequency of violation of the constraint conditions 13 (hereinafter referred to as “violation frequency”) and a maximum value of a violation amount representing whether the constraint conditions 13 are violated. Note that the violation frequency referred to herein means a frequency represented by the number of violations of the constraint conditions 13/the number of violations of all constraint conditions. Further, the machine learning section 12 determines evaluation indicator parameters on the basis of the violation frequency and the maximum value. The machine learning section 12 stores the parameters in the machine learning result storage DB 14 while linking the parameters with a schedule pattern obtained by learning schedule histories in the past in that way. Details of the machine learning section 12 are explained below.

The schedule planning section 15 has a function of applying the schedule pattern to input data to be scheduled, that is, data for which a schedule is newly planned to, as explained in detail below, calculate a transition probability of other products that could be arranged following the products and create a plurality of schedule candidates through random number selection using the transition probability as a weight.

The schedule evaluating section 16 has a function of selecting, for example, one schedule candidate as an optimum solution out of the plurality of schedule candidates created in the schedule planning section 15 according to the evaluation indicator (KPI) created by the machine learning section 12.

The schedule output section 17 has a function of outputting the schedule candidate evaluated by the schedule evaluating section 16 and selected as the optimum solution to the outside as a schedule candidate 17A.

### (1-3) Operation Example of Production Schedule Creating Apparatus

The production schedule creating apparatus 100 has the configuration explained above. An example of a production schedule creating method executed by the production schedule creating apparatus 100 is specifically explained below.

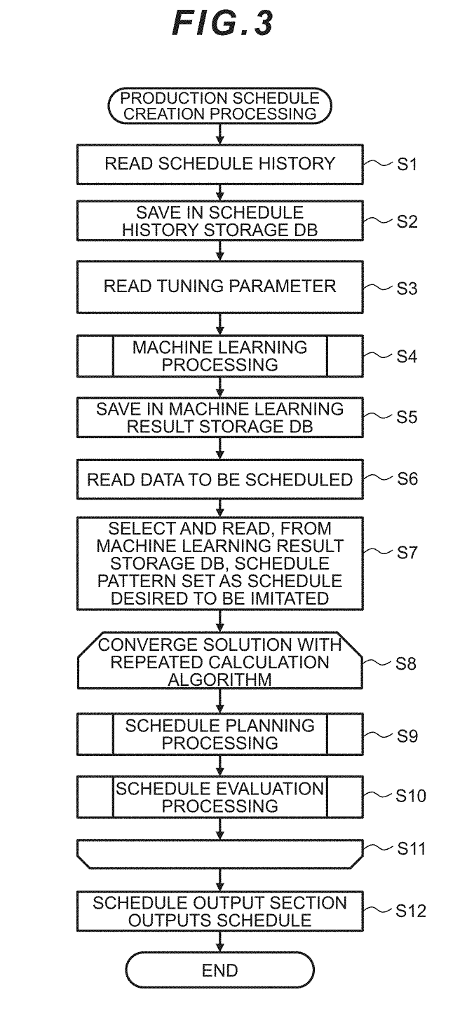

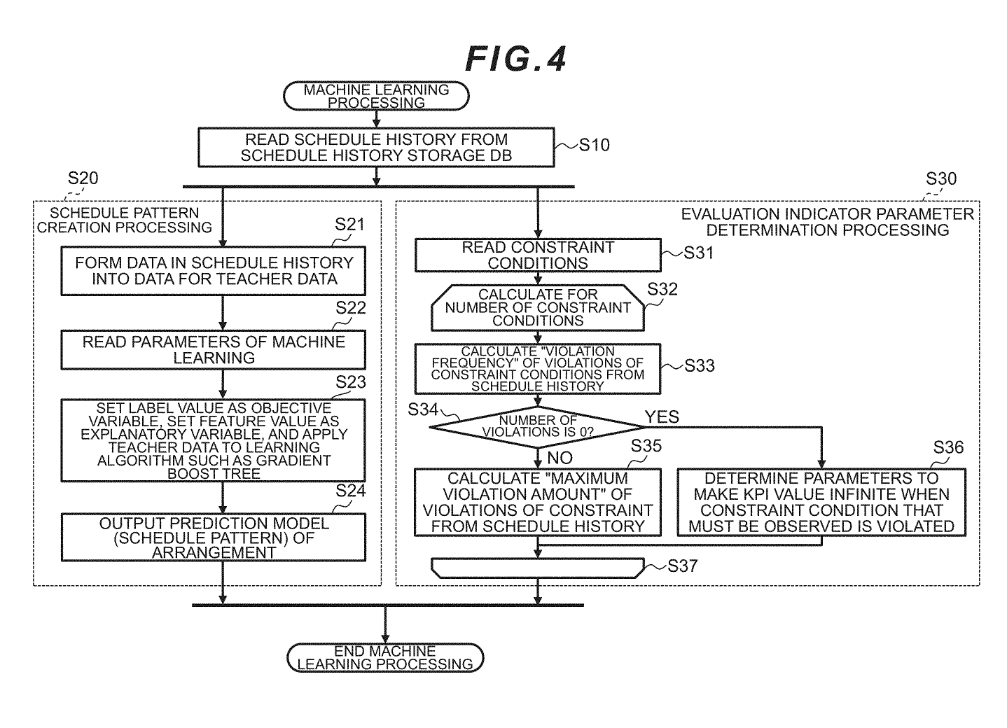

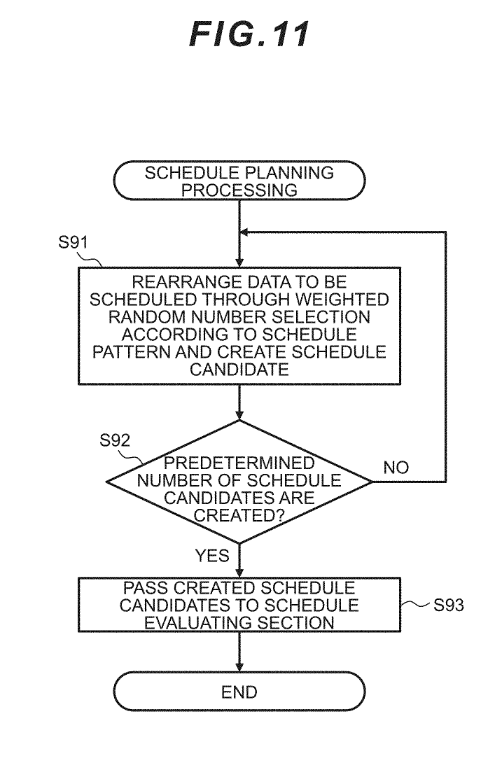

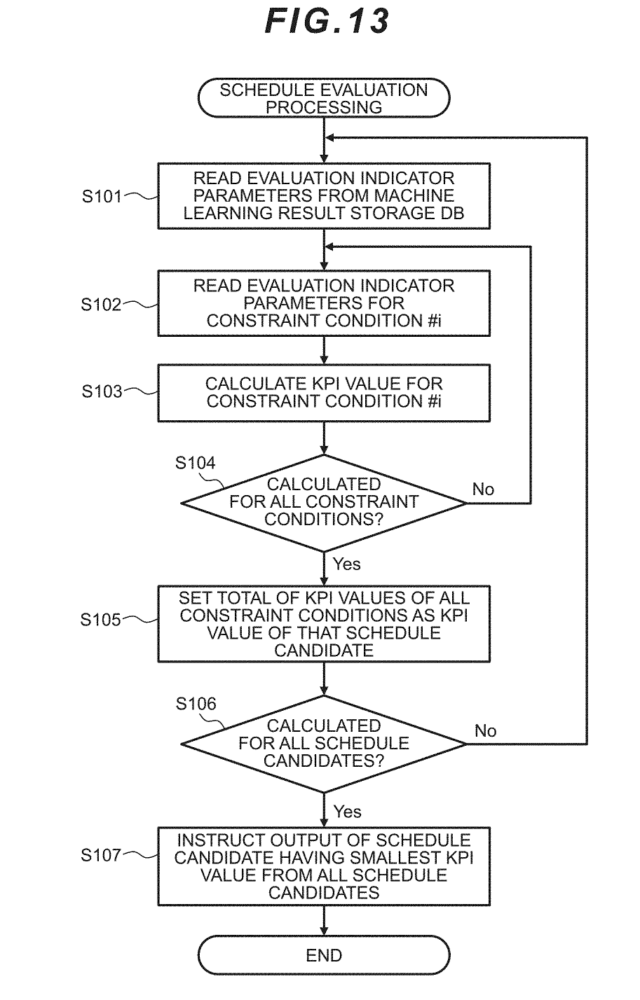

FIG. 3 shows an example of the production schedule creating method in the production schedule creating apparatus 100. FIG. 4 shows an example of machine learning processing shown in FIG. 3. FIG. 11 shows an example of schedule planning processing shown in FIG. 3. FIG. 13 shows an example of schedule evaluation processing shown in FIG. 3.

First, the production schedule creating apparatus 100 reads the schedule histories 11A, 11B, and 11C (step S1 in FIG. 3) and saves the schedule histories 11A, 11B, and 11C in the schedule history storage DB 11 (step S2 in FIG. 3).

In the schedule history storage database 11, as shown in FIG. 5, the schedule histories 11A, 11B, and 11C planned in the past are stored as a schedule history 11Z including, besides production order, product information including dimensions of products and information such as a planner ID representing a planner who is about to create a production schedule and production scheduled time.

Subsequently, a predetermined tuning parameter is read (step S3 in FIG. 3). Subsequently, machine learning processing explained below is executed (step S4 in FIG. 3). In the machine learning processing, the machine learning section 12 extracts and reads, from the schedule history storage DB 11, the schedule history 11Z, which is a learning target, for example, for each planner and each production scheduled time (step S10 in FIG. 4). Subsequently, schedule pattern creation processing S20 and evaluation indicator parameter determination processing S30 are executed, for example, simultaneously in parallel (or separately one by one).

### (1-3-1) Schedule Pattern Creation Processing

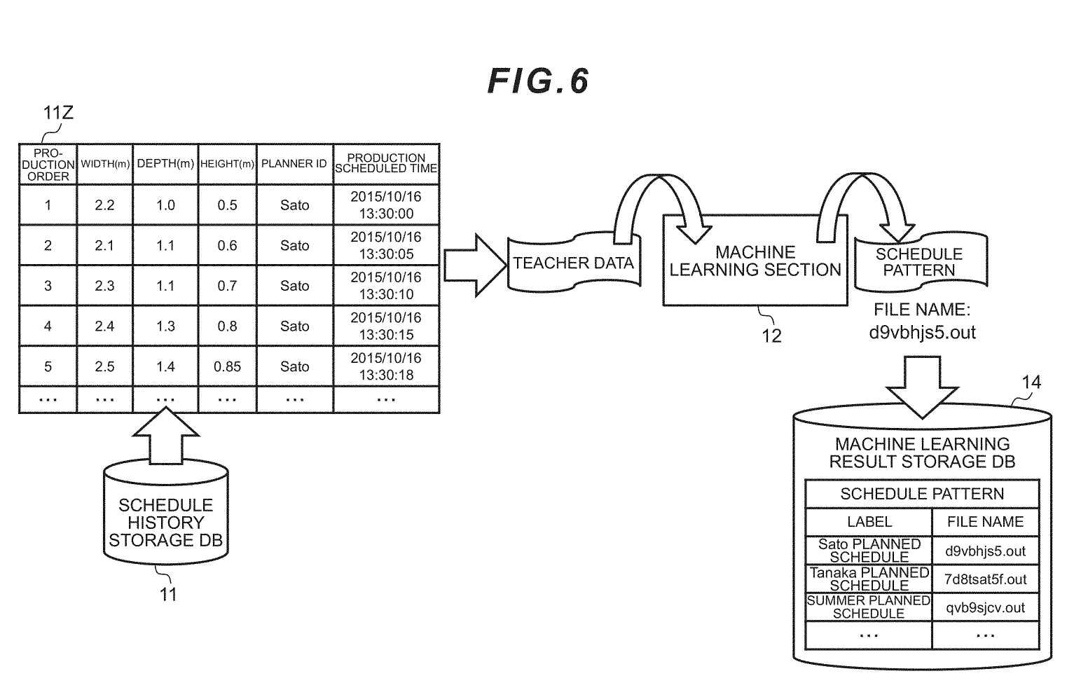

In the schedule pattern creation processing S20, first, as preprocessing, as shown in FIG. 6, the machine learning section 12 converts the schedule history 11Z of the schedule history storage DB 11 into a machine-learnable data format and forms teacher data (step S21 in FIG. 4). This processing is hereinafter referred to as “teacher data conversion processing”. In this case, the machine learning section 12 reads a parameter of machine learning (step S22 in FIG. 4).

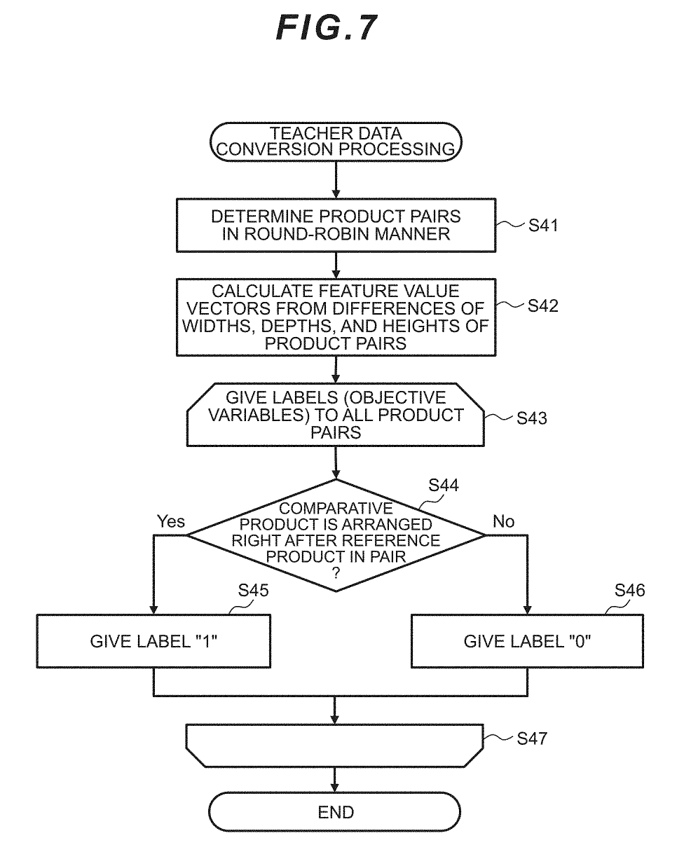

In the teacher data conversion processing, first, the machine learning section 12 determines, in a round-robin manner, product pairs formed by reference products and comparative products (step S41 in FIG. 7) and calculates feature value vectors on the basis of differences of widths, depths, and heights of the product pairs (step S42 in FIG. 7).

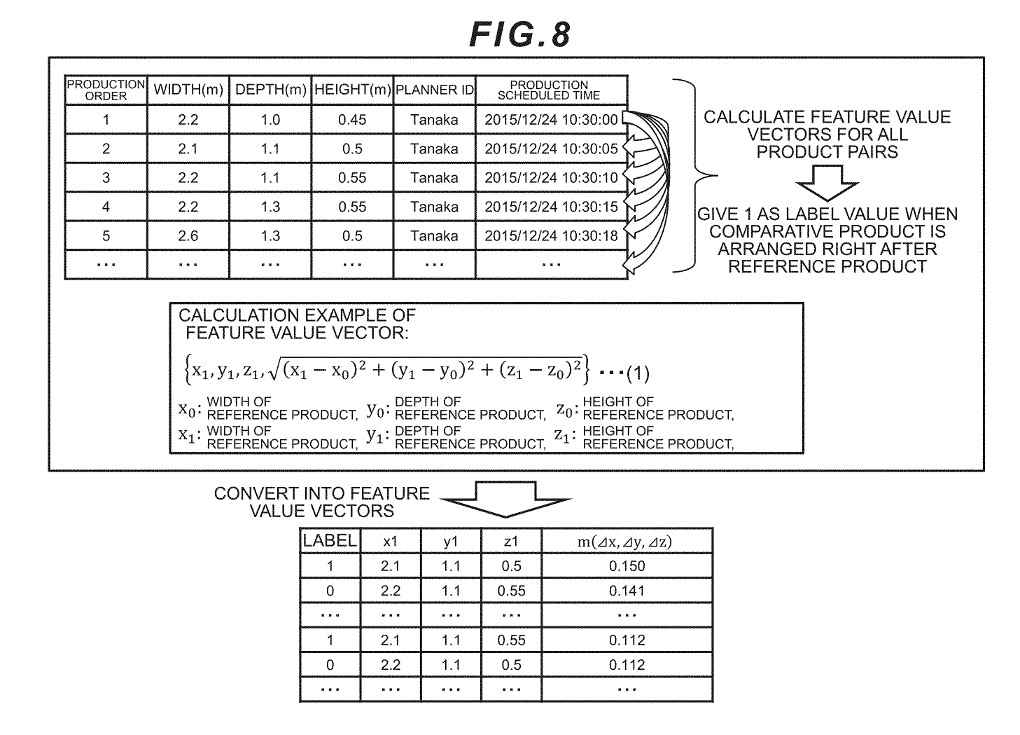

Specifically, as shown in FIG. 8, for example, the machine learning section 12 calculates feature vectors for all pairs of products concerning a schedule history using a calculation formula (1).

Subsequently, the machine learning section 12 give label values to all the product pairs as objective variables as explained below (step S43 and step S47 in FIG. 7). That is, the machine learning section 12 determines whether a comparative produce is arranged immediately after a product serving as a reference of a product pair (hereinafter referred to as “reference product”) (step S44 in FIG. 7). When the comparative product is arranged immediately after the reference product, the machine learning section 12 gives a “label 1” as an objective variable (step S45 in FIG. 7). In the case of another pair, the machine learning section 12 gives a “label 0” as an objective variable.

The machine learning section 12 sets the label value as the objective variable, sets a feature value based on the feature value vector as an explanatory variable, and applies the teacher data explained above to a learning algorithm such as a gradient boost tree (step S23 in FIG. 4).

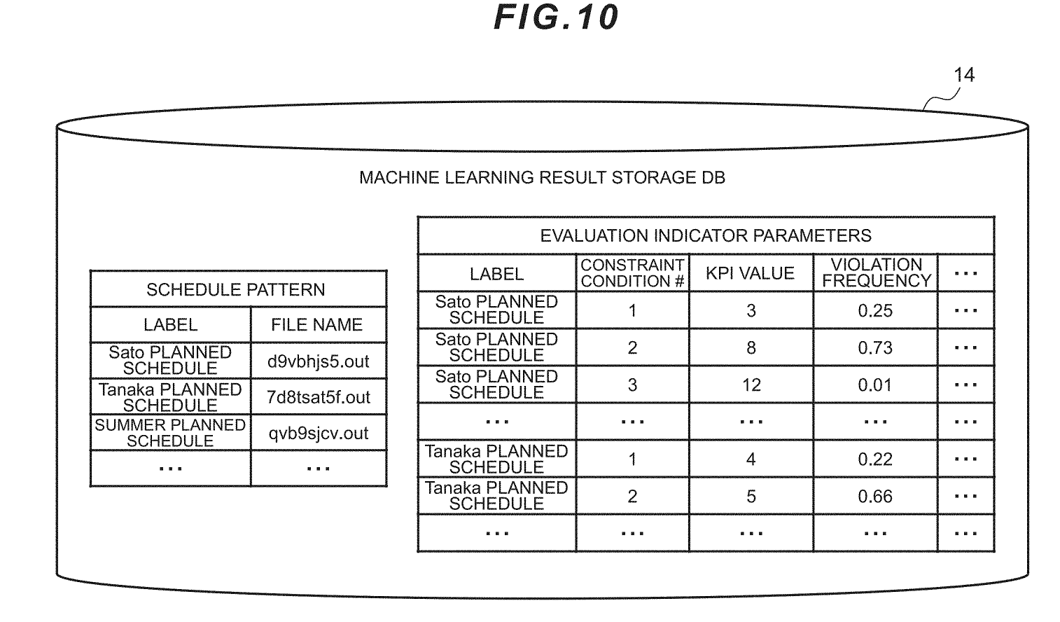

The teacher data is applied a machine learning method such as a gradient boost determination tree as explained above to thereby be modeled as a schedule pattern. The schedule pattern modeled in this way is given with a predetermined file name as shown in FIG. 10 and stored in the machine learning result storage DB 14 together with, for example, a label including text information representing a planner (step S5 in FIG. 3).

### (1-3-2) Evaluation Indicator Parameter Determination Processing

On the other hand, the machine learning section 12 executes evaluation indicator parameter determination processing explained below in parallel to the schedule pattern creation processing explained above (step S30 in FIG. 4).

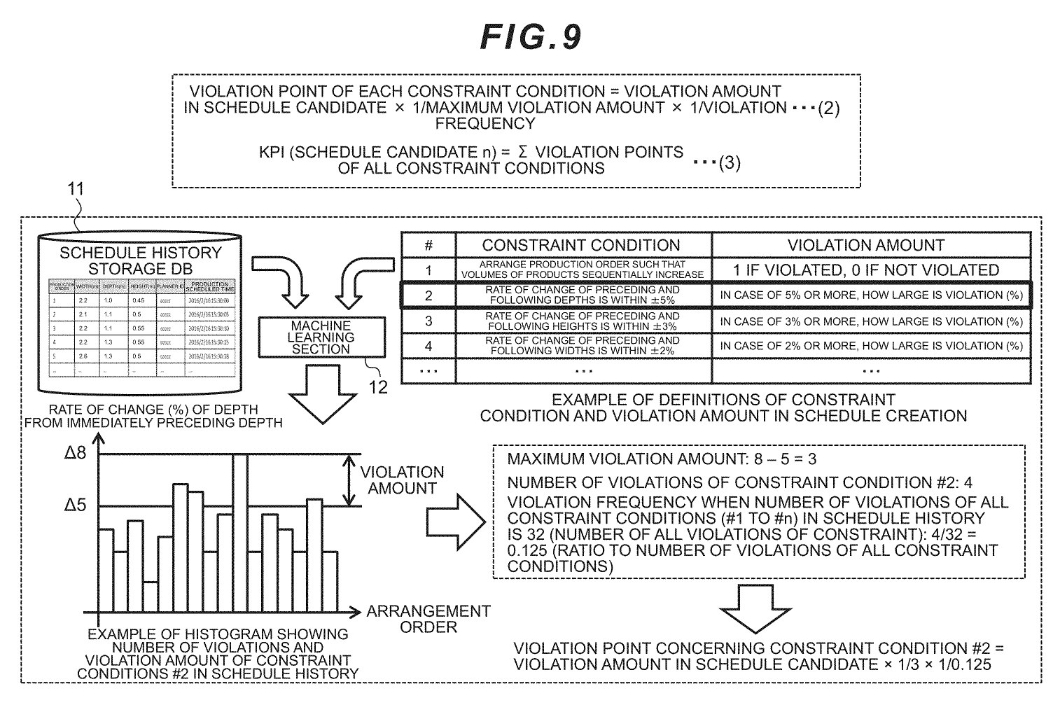

As an overview of the evaluation indicator parameter determination processing, as shown in FIG. 9, the machine learning section 12 determines an evaluation indicator parameter on the basis of a schedule history and constraint conditions read from the schedule history storage DB 11. In this embodiment, a case is illustrated in which, for example, in a certain schedule candidate n, a violation point calculated using Expression (3) on the basis of violation amounts of the constraint conditions is set as an evaluation indicator (equivalent to “KPI” shown in FIG. 9). FIG. 9 illustrates a calculation formula and a calculating method in that case.

First, as shown in the middle part of FIG. 9, the machine learning section 12 reads a schedule history and reads constraint conditions from the schedule history storage DB 11 (step S31 in FIG. 4). Subsequently, the machine learning section 12 executes the following processing (step S33 to step S36) for the number of the constraint conditions (step S32 and step S37 in FIG. 4).

The machine learning section 12 creates a histogram to be shown in production order (equivalent to “arrangement order” shown in FIG. 9) of products from the left as shown in the lower left of FIG. 9 for determining a value of a maximum violation amount (a deviation value indicating a degree of violation of a constraint condition) in Expression (2) shown in an upper part of FIG. 9 with which the schedule evaluating section 16 calculates a violation point. The histogram shows an example of the number of violations (the vertical axis) and a violation amount of a constraint condition #2, for example, in the case in which the horizontal axis indicates arrangement order of products in the schedule history read from the schedule history storage DB 11. In the example shown in FIG. 9, the maximum violation amount is 8−5=3 and the number of violations of the constraint condition #2 is 4.

The machine learning section 12 calculates a frequency of violation of the constraint conditions (equivalent to the “violation frequency” explained above) (step S33 in FIG. 4). The violation frequency is calculated using, for example, a formula: the number of violations of the constraint conditions/the (total) number of violations of all constraint conditions.

Subsequently, the machine learning section 12 determines whether the number of violations calculated as explained above is 0 (step S34 in FIG. 4).

As a result, when the number of violations is 0, the machine learning section 12 determines an evaluation indicator parameter to make a KPI value infinite when a specific constraint condition that must be always observed is violated (step S36 in FIG. 4).

On the other hand, when the number of violations is not 0, the machine learning section 12 calculates a maximum violation amount of the pertinent constraint condition (step S35 in FIG. 4).

Specifically, in the case of an example shown in the lower right of FIG. 9, when the number of violations of the constraint condition #2 is 4 and the number of violations of all constraint conditions (#1 to #n) in the schedule history is 32, the machine learning section 12 calculates a violation frequency as 4/32=0.125. That is, the violation frequency represents a ratio of the number of violations of the constraint condition #2 to the number of violations of all the constraint conditions.

As explained above, the machine learning section 12 determines, for each schedule history, “evaluation indicator parameters” including the maximum violation amount and the violation frequency for each of the constraint conditions # (constraint condition numbers).

The machine learning section 12 stores, as shown in FIG. 10, in the machine learning result storage DB 14, for example, information concerning the label representing the schedule pattern, the constraint conditions # for identifying the constraint conditions, the maximum violation amount serving as a first parameter, and the violation frequency serving as a second parameter as the determined evaluation indicator parameters while linking the label, the constraint conditions #, the maximum violation amount, and the violation frequency with the schedule pattern (step S5 in FIG. 3).

The machine learning section 12 reads, as data for which a schedule is about to be newly planned, data to be scheduled (step S6 in FIG. 3) selects and reads, from the machine learning result storage DB 14, a schedule pattern set as a schedule desired to be imitated (step S7 in FIG. 3).

Subsequently, schedule planning processing (step S9 in FIG. 3) and schedule evaluation processing (step S10 in FIG. 3) explained below are executed until a solution is converted by a repeated calculation algorithm (step S8 and step S11 in FIG. 3).

The schedule planning section 15 reads a schedule pattern from the machine learning result storage DB 14, rearranges the data to be scheduled through weighted random number selection according to the schedule pattern, and creates schedule candidates as explained below (step S91 in FIG. 11).

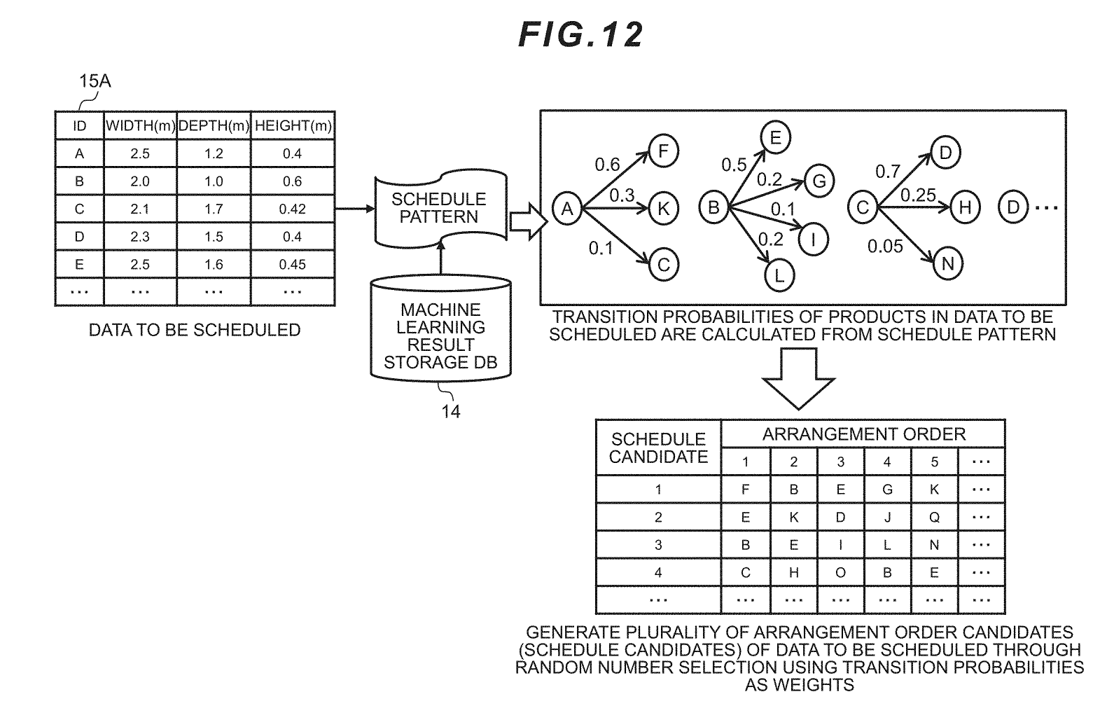

Specifically, the schedule planning section 15 applies the schedule pattern to the data to be scheduled and, for example, as shown in the upper right of FIG. 12, calculates a transition probability of another product F, which could be arranged following each product (a product A is illustrated), as 0.6, calculates a transition probability of another product K as 0.3, and calculates a transition probability of another product C as 0.1, and creates a plurality of schedule candidates 1 to 4 and the like as shown in the lower right of FIG. 12 through random number selection using these transition probabilities as weights.

The schedule planning section 15 determines whether a predetermined number of schedule candidates set in advance are created (step S92 in FIG. 11). If the predetermined number of schedule candidates are not created yet, the schedule planning section 15 executes step S92 again. On the other hand, if the predetermined number of schedule candidates are already created, the schedule planning section 15 passes the created predetermined number of schedule candidates 1 to 4 and the like to the schedule evaluating section 16 (step S93 in FIG. 11) and ends the processing.

Subsequently, in the schedule evaluation processing (step S10 in FIG. 3), the schedule evaluating section 16 selects, out of the predetermined number of schedule candidates 1 to 4 and the like created in the schedule planning section 15, a schedule candidate optimum as a solution on the basis of the evaluation indicator (KPI) created by the machine learning section 12.

Specifically, as shown in step S101 in FIG. 13, the schedule evaluating section 16 reads evaluation indicator parameters corresponding to all the constraint conditions from the machine learning result storage DB 14 in which the evaluation indicator parameters including the KPI value linked with the constraint conditions as explained above are stored (see FIG. 10).

The schedule evaluating section 16 reads, for example, evaluation indicator parameters for a constraint condition #i (i is a natural number) (step S102 in FIG. 13). Note that #i represents a number. The constraint condition #i represented as “constraint condition #2” indicates “constraint number 2”.

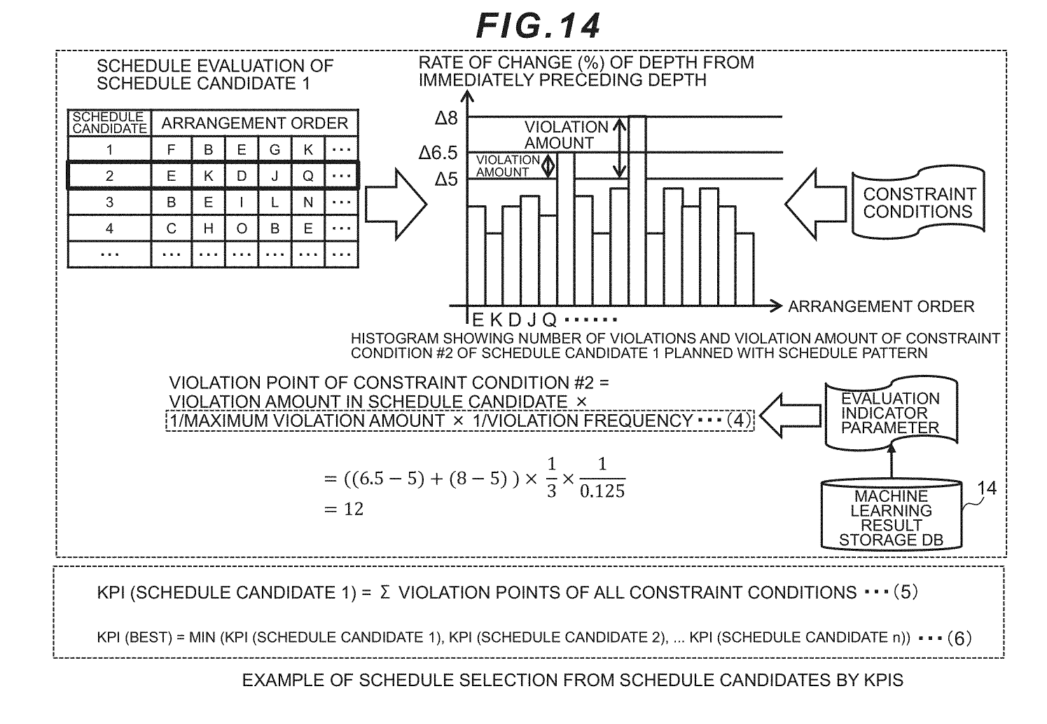

The schedule evaluating section 16 calculates a violation point (a value “12” in the example shown in FIG. 14) for the constraint condition #2 on the basis of, for example, an evaluation indicator parameter for the constraint condition #2 calculated according to Expression (4) illustrated in a middle part of FIG. 14 (step S103 in FIG. 13). The schedule evaluating section 16 repeats, concerning a schedule candidate 1 shown in the upper left of FIG. 14, step S102 and step S103 explained above until KPI values for all the constraint conditions are calculated using Expression (5) illustrated in a lower part of FIG. 14 (step S104 in FIG. 13).

The schedule evaluating section 16 sets, as a KPI value of the schedule candidate 2, a total of violation points of all the constraint conditions explained above (step 105 in FIG. 13).

Subsequently, the schedule evaluating section 16 determines, as an optimum schedule candidate, a specific schedule candidate having the smallest KPI value out of all schedule candidates 1 to n using Expression (6) shown in a lower part of FIG. 14 (step S105 in FIG. 13).

The schedule evaluating section 16 repeats step S101 to step S105 until KPI values are calculated for the number of all the schedule candidates (step 106 in FIG. 13).

The schedule evaluating section 16 selects, as an optimum schedule candidate, a specific schedule candidate having the smallest KPI value out of all the schedule candidates and instructs the schedule output section 17 to output the optimum schedule candidate (step S107 in FIG. 13).

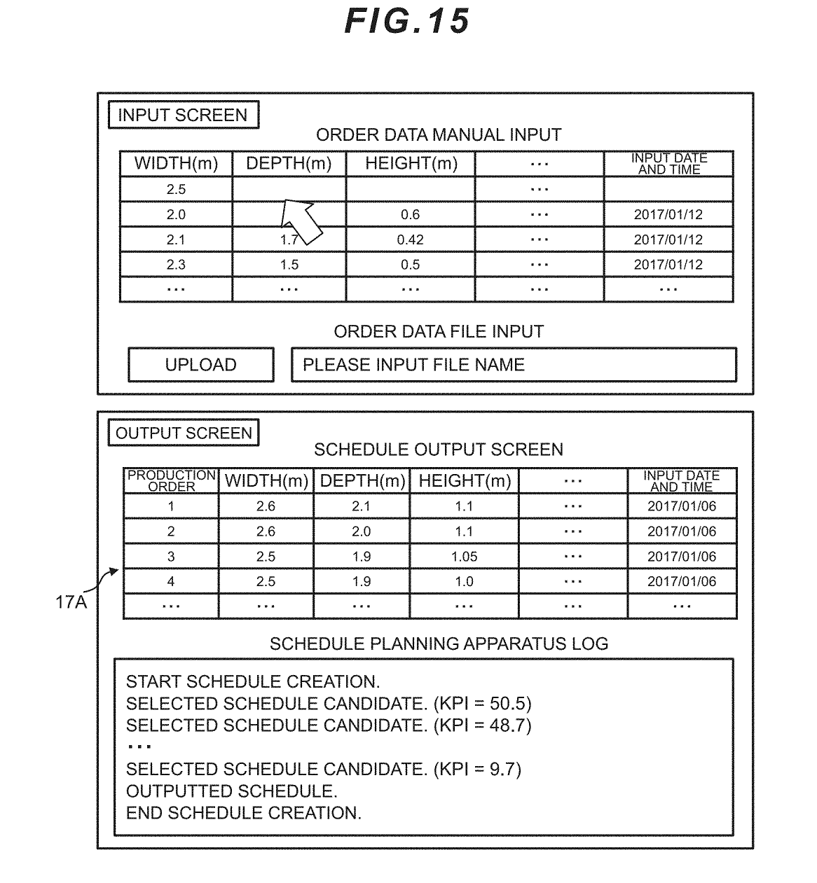

The schedule output section 17 outputs the optimum schedule candidate to the outside as a production schedule 17A on an output screen shown in a lower part of FIG. 15 (step S107 in FIG. 13). Note that, on the output screen shown in FIG. 15, a dedicated input screen shown in an upper part of FIG. 15 may be displayed together to, for example, make it possible to manually input order data, make it possible to input data to be scheduled serving as data for which a schedule is created, make it possible to upload a file of the data to be scheduled, and display an interim progress log of schedule creation to a schedule planner as a schedule planning apparatus log.

### (1-4) Effects and the Like of this Embodiment

According to the above explanation, with the production schedule creating apparatus 100 in the embodiment, it is possible to plan and provide a new production schedule reflecting characteristics and tendencies appearing in production schedules planned in the past.

### (1-5) Application Examples

### (1-5-1) First Modification

In a first modification in the first embodiment, a schedule candidate created before is taken over when a schedule candidate is created thereafter. The optimum schedule candidate selected by the schedule evaluating section 16 is re-applied to the schedule planning processing by the schedule planning section 15. A recursive calculation logic such as ant colony optimization or a genetic algorithm is applied. Consequently, it is possible to improve accuracy of the optimum schedule candidate serving as a finally calculated solution.

### (1-5-2) Second Modification

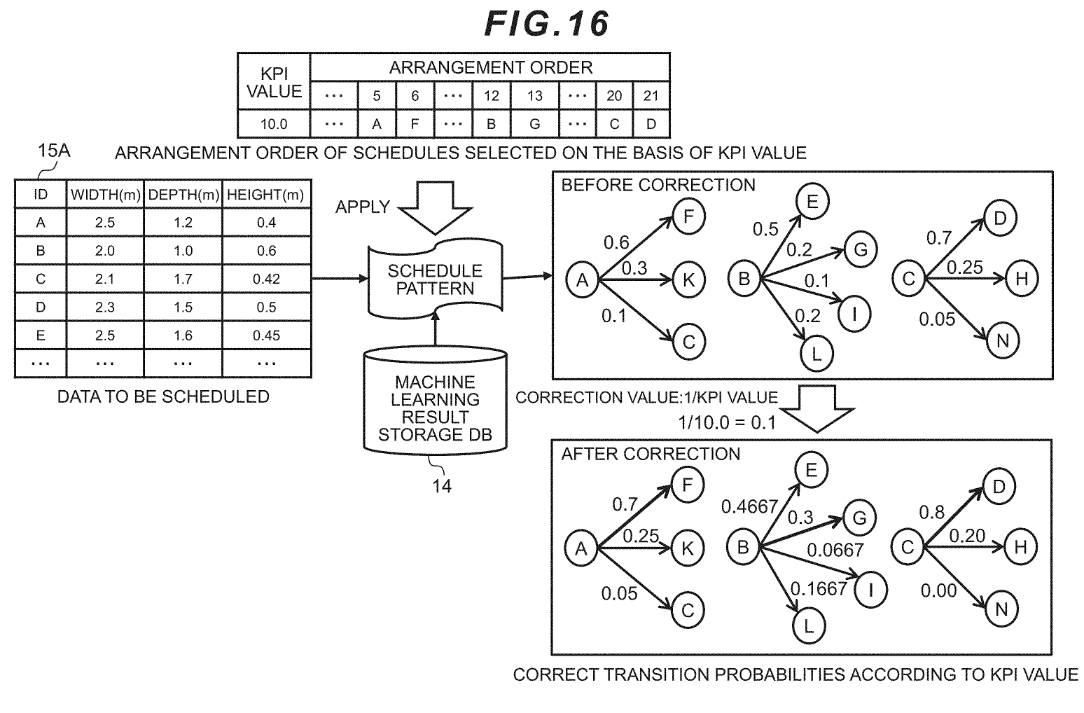

FIG. 16 shows a second modification in the first embodiment. The schedule evaluating section 16 selects the optimum schedule candidate as explained above in the schedule planning processing shown in FIG. 12. A transition probability among products used in the schedule planning processing may be corrected as explained below.

That is, the schedule evaluating section 16 corrects the transition probability to 1/KPI value=1/10.0=0.1 in an example shown in FIG. 16 using, for example, the inverse (a 1/KPI value) of the KPI value of the optimum schedule candidate calculated in the schedule planning processing. Consequently, it is possible to improve accuracy of the optimum schedule candidate repeatedly calculated and finally selected in the schedule planning processing shown in FIG. 12.

### (2) Second Embodiment

### (2-1) Configuration of Production Schedule Creating Apparatus According to Second Embodiment

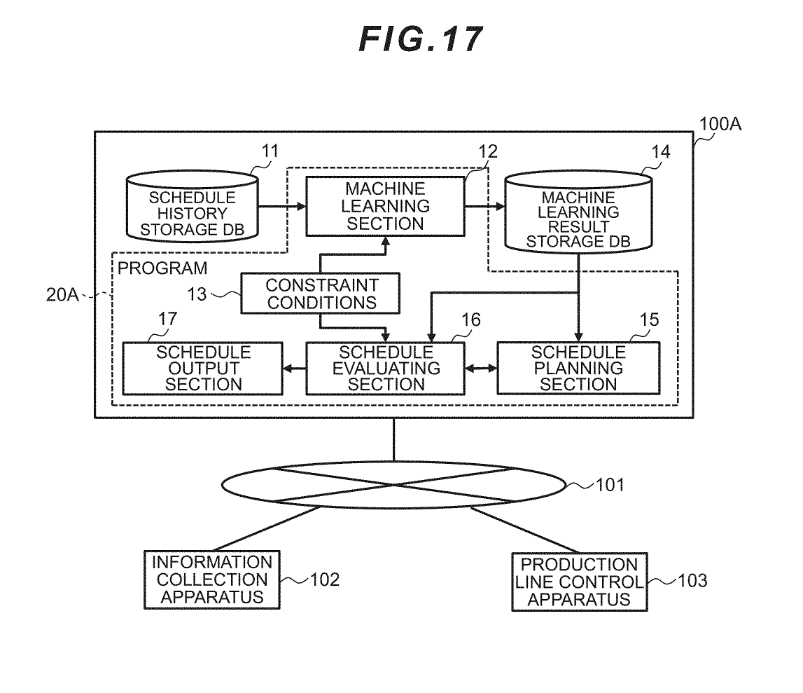

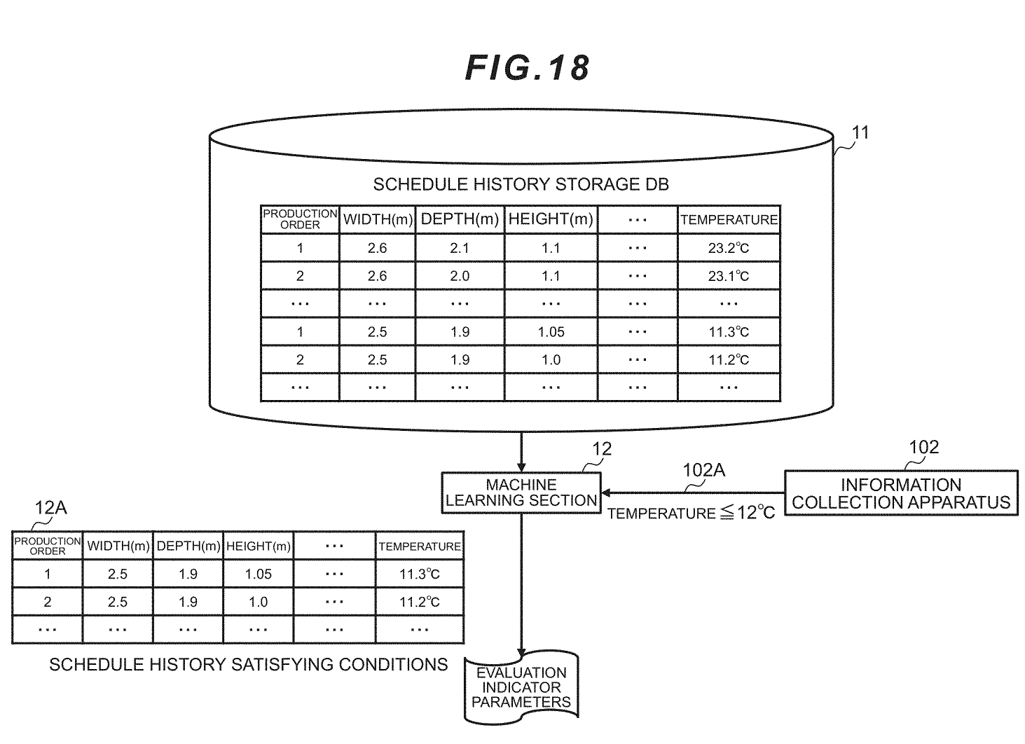

FIG. 17 shows a configuration example of a production schedule creating apparatus 100A according to a second embodiment. FIG. 18 shows an example in which an optimum production schedule is determined by the configuration shown in FIG. 17 in cooperation with an external sensor or an external system.

The production schedule creating apparatus 100A according to the second embodiment have a configuration and operation substantially the same as the configuration and the operation of the production schedule creating apparatus 100 according to the first embodiment. Therefore, explanation is omitted concerning the same configuration and the same operation. Differences between the first and second embodiments are mainly explained below.

In the second embodiment, unlike the first embodiment, besides an information collection apparatus 102 such as an external sensor, a production line control apparatus 103 that performs exchange of data, parameters, and the like via an input interface is provided as an example of an external system.

In the second embodiment, the production schedule creating apparatus 100A captures data or parameters acquired from the information collection apparatus 102 and the production line control apparatus 103 and dynamically tunes a KPI value according to an external environment to create a production schedule.

In the production schedule creating apparatus 100A, temperature data 102A measured when the created production schedule is applied to an actual manufacturing line is stored in the schedule history storage DB 11 in advance.

In the production schedule creating apparatus 100A, when planning a production schedule, the schedule planning section 15 extracts, on the basis of the temperature data 102A automatically acquired from the information collection apparatus 102 as shown in FIG. 18, a schedule history 12A, which satisfies a condition of a specific temperature or a specific temperature range (12 degrees or less in an example shown in FIG. 18), from the schedule history storage DB 11 and determines a KPI value. The schedule planning section 15 creates and plans an optimum production schedule under the present temperature condition based on the temperature data 102A.

### (2-2) Effects and the like of this embodiment

According to the above explanation, concerning a product easily affected by manufacturing conditions such as temperature, it is possible to accurately manufacture the product on the basis of an optimum production schedule.

### (3) Other Embodiments

The embodiments explained above are illustrations for explaining the present invention and are not meant to limit the present invention to only these embodiments. The present invention can be carried out in various forms without deviating from the gist of the present invention. For example, in the embodiments, the processing of the various programs are sequentially explained. However, the present invention is not particularly limited to this. Therefore, the order of the processing may be changed or the processing maybe configured to operate in parallel unless contradiction occurs in a processing result.

### INDUSTRIAL APPLICABILITY

The present invention can be widely applied to a production schedule creating apparatus and a production schedule creating method for creating and proposing a production schedule of products.

### REFERENCE SIGNS LIST

11 Schedule history storage DB
12 Machine learning section
14 Machine learning result storage DB
15 Schedule planning section
16 Schedule evaluating section
17 Schedule output section
100, 100A Production schedule creating apparatus

1. A production schedule creating apparatus comprising:
a schedule planning section that calculates, on the basis of history information concerning production schedules of products planned in the past, a schedule pattern including production order of the products while considering constraint conditions in producing the products, rearranges the production order of the products according to the schedule pattern, and creates a plurality of schedule candidates concerning a production schedule of the products; and
a schedule evaluating section that evaluates the plurality of schedule candidates on the basis of evaluation indicators corresponding to the constraint conditions, and selects a best production schedule out of the plurality of schedule candidates.

2. The production schedule creating apparatus according to claim 1, wherein the schedule planning section creates the plurality of schedule candidates on the basis of weighting corresponding to a probability obtained by applying the schedule pattern to data to be scheduled representing characteristics of products for which a production schedule is newly created, the probability being a transition probability of products to be produced following the products.

3. The production schedule creating apparatus according to claim 2, wherein, when a specific constraint condition that has to be always satisfied is present among the constraint conditions, the schedule planning section creates the plurality of schedule candidates to satisfy the specific constraint condition.

4. The production schedule creating apparatus according to claim 3, wherein
the schedule planning section calculates a plurality of evaluation indicator values corresponding to the plurality of schedule candidates on the basis of the evaluation indicators tuned using the history information, and
the schedule evaluating section selects, as the best production schedule, a production schedule corresponding to a best evaluation indicator value among the evaluation indicator values of the plurality of schedule candidates.

5. The production schedule creating apparatus according to claim 4, wherein the schedule evaluating section selects, as the best production schedule, a specific schedule candidate having a smallest sum of the evaluation indicator values among the evaluation indicator values of the constraint conditions calculated concerning the plurality of schedule candidates.

6. The production schedule creating apparatus according to claim 1, wherein the schedule evaluating section dynamically tunes the evaluation indicators on the basis of data collected from an external system, evaluates the plurality of schedule candidates on the basis of new evaluation indicators after the tuning, and selects the best production schedule out of the plurality of schedule candidates.

7. The production schedule creating apparatus according to claim 1, wherein the schedule evaluating section repeatedly executes the evaluation based on the evaluation indicators by applying a recursive algorithm to a process up to the selection of the best production schedule.

8. A production schedule creating method in a production schedule creating apparatus that creates a production schedule of produces, the production schedule creating method comprising:
a schedule planning step in which the production schedule creating apparatus calculates, on the basis of history information concerning production schedules of products planned in the past, a schedule pattern including production order of the products while considering constraint conditions in producing the products, rearranges the production order of the products according to the schedule pattern, and creates a plurality of schedule candidates concerning a production schedule of the products; and
a schedule evaluating step in which the production schedule creating apparatus evaluates the plurality of schedule candidates on the basis of evaluation indicators corresponding to the constraint conditions, and selects a best production schedule out of the plurality of schedule candidates.

9. The production schedule creating method according to claim 8, wherein, in the schedule planning step, the production schedule creating apparatus creates the plurality of schedule candidates on the basis of weighting corresponding to a probability obtained by applying the schedule pattern to data to be scheduled representing characteristics of products for which a production schedule is newly created, the probability being a transition probability of products to be produced following the products.

10. The production schedule creating method according to claim 9, wherein, in the schedule planning step, when a specific constraint condition that has to be always satisfied is present among the constraint conditions, the production schedule creating apparatus creates the plurality of schedule candidates to satisfy the specific constraint condition.

11. The production schedule creating method according to claim 10, wherein
in the schedule planning step, the production schedule creating apparatus calculates a plurality of evaluation indicator values corresponding to the plurality of schedule candidates on the basis of the evaluation indicators tuned using the history information, and
in the schedule evaluating step, the production schedule creating apparatus selects, as the best production schedule, a production schedule corresponding to a best evaluation indicator value among the evaluation indicator values of the plurality of schedule candidates.

12. The production schedule creating method according to claim 11, wherein, in the schedule evaluating step, the production schedule creating apparatus selects, as the best production schedule, a specific schedule candidate having a smallest sum of the evaluation indicator values among the evaluation indicator values of the constraint conditions calculated concerning the plurality of schedule candidates.

13. The production schedule creating method according to claim 8, wherein, in the schedule evaluating step, the production schedule creating apparatus dynamically tunes the evaluation indicators on the basis of data collected from an external system, evaluates the plurality of schedule candidates on the basis of new evaluation indicators after the tuning, and selects the best production schedule out of the plurality of schedule candidates.

14. The production schedule creating method according to claim 8, wherein, in the schedule evaluating step, the production schedule creating apparatus repeatedly executes the evaluation based on the evaluation indicators by applying a recursive algorithm to a process up to the selection of the best production schedule.

15. A production schedule creating program for causing a computer to execute:
a schedule planning step for calculating, on the basis of history information concerning production schedules of products planned in the past, a schedule pattern including production order of the products while considering constraint conditions in producing the products, rearranging the production order of the products according to the schedule pattern, and creating a plurality of schedule candidates concerning a production schedule of the products; and
a schedule evaluating step for evaluating the plurality of schedule candidates on the basis of evaluation indicators corresponding to the constraint conditions, and selecting a best production schedule out of the plurality of schedule candidates.
